(19) United States
(12) Patent Application Publication
(10) Pub. No.: US 2026/0370920 A1
(43) Pub. Date: Nov. 19, 2026

(54) CONTENT INTERACTION METHOD AND APPARATUS, COMPUTER DEVICE, AND PROGRAM PRODUCT

(71) Applicant: Tencent Technology (Shenzhen) Company Limited, Shenzhen (CN)

(72) Inventor: Shangzhen ZHENG, Shenzhen (CN)

(21) Appl. No.: 19/724,379

(22) Filed: Jun. 29, 2026

Related U.S. Application Data
(63) Continuation of application No. PCT/CN2025/107694, filed on Jul. 9, 2025.

(30) Foreign Application Priority Data
Aug. 29, 2024 (CN) 202411204593.3

(51) Int. Cl. H04N 21/8541; G06F 3/04817; H04N 21/466; H04N 21/4788

(52) U.S. Cl. CPC H04N 21/8541; G06F 3/04817; H04N 21/4668; H04N 21/4788

(57) ABSTRACT

This application disclose a content interaction method performed by a computer device. After target content is obtained, a multi-person production control is displayed to grant permission to upload target branch content to another account. If a trigger operation performed on the multi-person production control is obtained, a multi-version production range for the target content is configured to present a plurality of pieces of branch content. The multi-version content has a multi-person production identifier for representing that the target content supports presenting a plurality of pieces of branch content in a multi-version production range, and the plurality of pieces of branch content are obtained by uploading based on a plurality of accounts. Therefore, a plurality of pieces of branch content for the same multi-version content may be produced and uploaded by a plurality of creators, thereby reducing production difficulty and workload of each creator.

### CROSS-REFERENCE TO RELATED APPLICATIONS

This application is a continuation application of PCT Patent Application No. PCT/CN2025/107694, entitled “CONTENT INTERACTION METHOD AND APPARATUS, COMPUTER DEVICE, AND PROGRAM PRODUCT” filed on Jul. 9, 2025, which claims priority to Chinese Patent Application No. 202411204593.3, entitled “CONTENT INTERACTION METHOD AND APPARATUS, COMPUTER DEVICE, AND PROGRAM PRODUCT” and filed with the China National Intellectual Property Administration on Aug. 29, 2024, both of which are incorporated herein by reference in their entirety.

### FIELD OF THE TECHNOLOGY

The present disclosure relates to the field of Internet technologies, and more specifically, to content interaction.

### BACKGROUND OF THE DISCLOSURE

Multi-version content refers to that content can have a plurality of different versions of story plots, that is, a plurality of pieces of branch content. For example, a video recording a journey from place A to place B using different modes of transportation may generate a plurality of different versions of video content, and each version of video content represents a piece of branch content. Viewers may choose different branch content while viewing multi-version content, thereby enjoying different viewing experiences and enhancing user experience.

In the related art, multi-version content is produced by a creator of the multi-version content. The production difficulty is high, and the workload is high.

### SUMMARY

To resolve the foregoing technical problems, this application provides a content interaction method and apparatus, a computer device, and a program product, to reduce difficulty in producing multi-version content and reduce workload of a creator.

Embodiments of this application disclose the following technical solutions.

According to a first aspect, an embodiment of this application provides a content interaction method performed by a computer device, the method including:
receiving a message from a blogger, wherein the message includes an identifier of multi-version content, an identifier of a first branch content, and a multi-person production identifier, wherein the multi-person production identifier indicates that the blogger allows presenting a plurality of pieces of branch content in a multi-version production range of the multi-version content;
displaying a graphical user interface on a screen of the computer device, the graphical user interface including a first icon corresponding to the multi-version content, a second icon corresponding to the first branch content, and a multi-version production control corresponding to the multi-person production identifier;
in response to obtaining a selection operation performed on the multi-version production control, uploading, to a remote server, target branch content chosen by the viewer from a plurality of candidate branch contents;
after the target branch content is successfully uploaded, adding the target branch content as one of the plurality of pieces of branch content presented in the multi-version production range of the multi-version content; and
adding a third icon corresponding to the first branch content to the graphical user interface on the screen.

According to a second aspect, an embodiment of this application provides a computer device, including: a processor and a memory,
the memory being configured to store a computer program, and transmit the computer program to the processor; and
the processor being configured to perform, according to instructions in the computer program, the content interaction method according to the foregoing aspects.

According to a third aspect, an embodiment of this application provides a non-transitory computer-readable storage medium, configured to store a computer program, the computer program, when executed by a processor of a computer device, being configured to cause the computer device to perform the method according to the foregoing aspects.

It can be seen from the foregoing technical solutions that, after target content is obtained, a multi-person production control is displayed. The multi-person production control is configured to grant permission to another account to upload branch content for the target content. If a trigger operation performed on the multi-person production control is obtained, a multi-version production range for the target content, that is, a part of the target content is configured to present a plurality of pieces of branch content, is set. After the multi-version production range has been set, the multi-version content is uploaded. The multi-version content is target content having a multi-person production identifier, the multi-person production identifier is configured for representing that the target content supports presenting a plurality of pieces of branch content in a multi-version production range, and the plurality of pieces of branch content are obtained by uploading based on a plurality of accounts.

Therefore, by using the multi-person production control, permission to upload branch content for the target content may be granted to another account, that is, a plurality of pieces of branch content for the same multi-version content may be produced and uploaded by a plurality of creators, thereby reducing production difficulty and workload of each creator.

### BRIEF DESCRIPTION OF THE DRAWINGS

FIG. 1 is a schematic diagram of multi-version content according to an embodiment of this application.

FIG. 2 is a schematic diagram of an application scenario of a content interaction method according to an embodiment of this application.

FIG. 3 is a schematic flowchart of a content interaction method according to an embodiment of this application.

FIG. 4 is a schematic diagram of displaying a multi-person production control according to an embodiment of this application.

FIG. 5 is a schematic diagram of setting a multi-version production range according to an embodiment of this application.

FIG. 6 is a schematic diagram of a user permission control according to an embodiment of this application.

FIG. 7 is a schematic diagram of a user permission control according to an embodiment of this application.

FIG. 8 is a schematic diagram of a user permission control according to an embodiment of this application.

FIG. 9 is a schematic diagram of displaying a branch content quantity control and a user permission control according to an embodiment of this application.

FIG. 10 is a schematic flowchart of a content interaction method according to an embodiment of this application.

FIG. 11 is a schematic diagram of uploading branch content according to an embodiment of this application.

FIG. 12 is a signaling interworking diagram of uploading target branch content according to an embodiment of this application.

FIG. 13 is a schematic flowchart of a content interaction method according to an embodiment of this application.

FIG. 14 is a signaling interworking diagram of viewing multi-version content according to an embodiment of this application.

FIG. 15 is a schematic diagram of a content interaction method according to an embodiment of this application.

FIG. 16 is a schematic structural diagram of a content interaction apparatus according to an embodiment of this application.

FIG. 17 is a schematic structural diagram of a content interaction apparatus according to an embodiment of this application.

FIG. 18 is a schematic structural diagram of a server according to an embodiment of this application.

FIG. 19 is a schematic structural diagram of a terminal device according to an embodiment of this application.

### DESCRIPTION OF EMBODIMENTS

Embodiments of this application are described below with reference to the accompanying drawings.

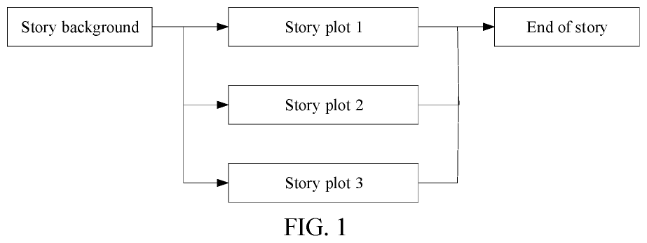

Content may be video content, article content, novel content, or the like. The multi-version content includes a plurality of pieces of branch content. FIG. 1 is a schematic diagram of multi-version content according to an embodiment of this application. In FIG. 1, the multi-version content is video content, and the video content has a plurality of pieces of branch content in a middle period of time, which are respectively a plot 1, a plot 2, and a plot 3. A viewer may choose any plot to view, thereby enhancing a sense of participation of the viewer.

In the related art, multi-version content is produced by a creator of the multi-version content alone. For example, the three plots in FIG. 1 all need to be produced by the creator of the video content. Production difficulty is high, and workload is high for the creator.

Based on this, an embodiment of this application provides a content interaction method. A creator of target content may perform a trigger operation by using a multi-person production control, to grant permission to another account to upload branch content for the target content, so that a plurality of pieces of branch content for the multi-version content may be produced and uploaded by a plurality of creators, thereby reducing production difficulty and workload of each creator.

The content interaction method provided in this application may be applied to a computer device having a content interaction capability, such as a terminal device or a server.

The terminal device may be specifically, but is not limited to, a desktop computer, a notebook computer, a smartphone, a tablet computer, an Internet of Things device, and a portable wearable device, where the Internet of Things device may be a smart speaker, a smart television, a smart air conditioner, a smart in-vehicle device, or the like, the smart in-vehicle device may be an in-vehicle navigation terminal, an in-vehicle computer, or the like, and the portable wearable device may be a smart watch, a smart band, a headset device, or the like.

The server may be an independent physical server, or may be a server cluster or distributed system formed by a plurality of physical servers, or may be a cloud server or server cluster that provides basic cloud computing services such as a cloud service, a cloud database, cloud computing, a cloud function, cloud storage, a network service, cloud communication, a middleware service, a domain name service, a security service, a content delivery network (CDN), and a big data and AI platform. The terminal device and the server may be directly or indirectly connected in a wired or wireless communication manner. This is not limited in this application.

To facilitate understanding of the content interaction method provided in this embodiment of this application, an application scenario of the content interaction method is exemplarily described below by using an example in which the content interaction method is performed by a server.

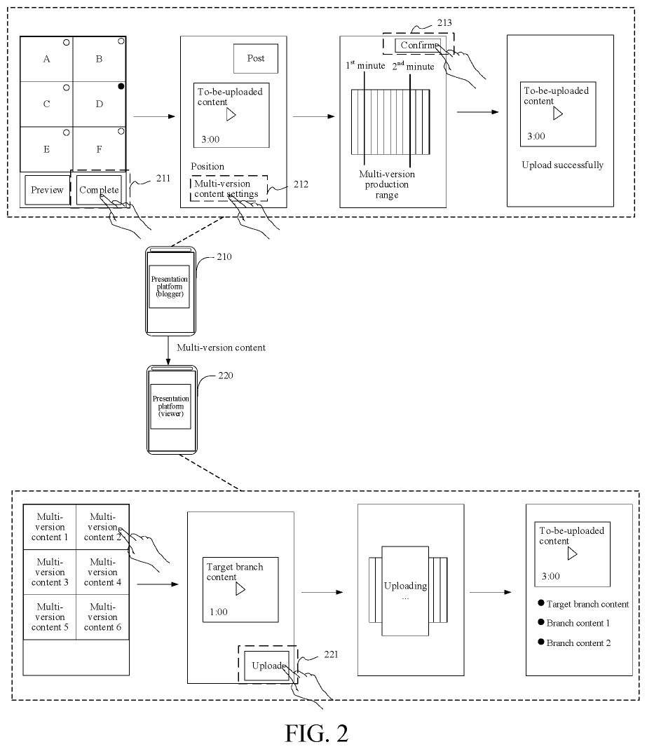

FIG. 2 is a schematic diagram of an application scenario of a content interaction method according to an embodiment of this application. As shown in FIG. 2, the application scenario includes a terminal device 210 and a terminal device 220. The terminal device 210 and the terminal device 220 may directly communicate with each other via a communication network, or may indirectly communicate with each other by using a server via a communication network. The communication network uses a standard communication technology and/or protocol, and is usually the Internet, but may alternatively be any other network, including but not limited to, Bluetooth, a local area network (LAN), a metropolitan area network (MAN), a wide area network (WAN), or any combination of a mobile network, a dedicated network, or a virtual dedicated network. In some embodiments, the foregoing data communication technology may be replaced or supplemented by using a customized or dedicated data communication technology. In this embodiment, multi-version content is video content.

Uploading of the multi-version content by a blogger is described below first. The blogger is a user uploading target content.

A client configured to provide a content interaction service is installed on the terminal device 210, and the client can provide a blogger with a service of uploading video content. After selecting the target content by using the client, the blogger clicks/taps an uploading control 211 (that is, a control marked as “Complete” in FIG. 2) to upload the target content (that is, content D shown in FIG. 2) produced by the blogger. After obtaining the target content, the terminal device 210 displays a multi-person production control 212 (that is, a control marked as a “Multi-version content settings” in FIG. 2). After the blogger clicks/taps the multi-person production control 212, it indicates that the blogger grants permission to another creator production for the target content, that is, the another creator may produce at least one piece of branch content for the target content. The blogger needs to set a multi-version production range for the target content, that is, a part of video content in the target content that may have other branch content. As shown in FIG. 2, the target content is a 3-minute video. The blogger sets a time period from the 1^{st} minute to the 2^{nd} minute as the multi-version production range, and a plurality of pieces of branch content may be corresponding within the multi-version production range. After determining that the multi-version production range has been set, for example, after clicking/tapping a confirmation control 213 (that is, a control marked as “Confirm” in FIG. 2), the blogger uploads multi-version content. The multi-version content is target content having a multi-person production identifier, the multi-person production identifier is configured for representing that the target content supports presenting a plurality of pieces of branch content in a multi-version production range, and the plurality of pieces of branch content are obtained by uploading based on a plurality of accounts.

Uploading branch content for the multi-version content by a viewer is then described. The viewer is a user that produces branch content for the target content, or a user that views the target content.

A client configured to provide a content interaction service is installed on the terminal device 220, and the client can provide a viewer with services of viewing and uploading branch content. The viewer may choose which multi-version content to upload branch content for. As shown in FIG. 2, after selecting multi-version content 2, the viewer clicks/taps an uploading control 221 (that is, a control marked as “Upload” in FIG. 2) to upload target branch content for the multi-version content. If the target branch content is successfully uploaded, the target branch content is determined as one of a plurality of pieces of branch content presented in the multi-version production range of the multi-version content. For example, the multi-version content in FIG. 2 includes three pieces of branch content, namely, branch content 1, branch content 2, and the target branch content.

Therefore, by using the multi-person production control, permission to upload branch content for the target content may be granted to another account, that is, a plurality of pieces of branch content for the same multi-version content may be produced and uploaded by a plurality of creators, thereby reducing production difficulty and workload of each creator.

The content interaction method provided in this embodiment of this application may be performed by a terminal device. However, in another embodiment of this application, a server may also have similar functions to the terminal device, to perform the content interaction method provided in this embodiment of this application, or the terminal device and the server jointly perform the content interaction method provided in this embodiment of this application. This is not limited in this embodiment.

A content interaction method provided in this application is described below in detail by using a method embodiment. This embodiment of this application provides a manner in which a blogger uploads multi-version content and grants permission to a viewer to upload branch content, and the viewer uploads branch content. The following first describes that the blogger uploads the multi-version content and grants the permission to the viewer to upload branch content.

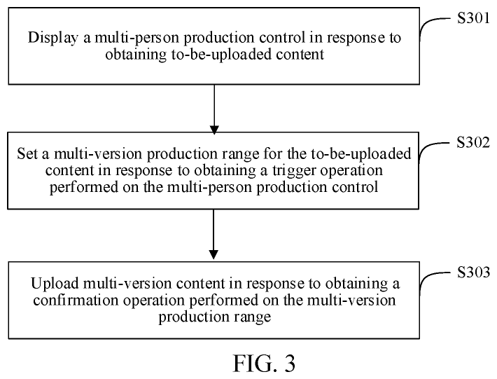

FIG. 3 is a schematic flowchart of a content interaction method according to an embodiment of this application. For ease of description, the following embodiment is still described by using an example in which the content interaction method is performed by a terminal device. As shown in FIG. 3, the content interaction method includes S301 to S303.

S301: Display a multi-person production control in response to obtaining target content.

The target content is content waiting to be uploaded, and may be text content, video content, or the like. The video content may be for a game, a TV series, or the like. The multi-person production control is a control configured to grant permission to the viewer to upload branch content.

FIG. 4 is a schematic diagram of displaying a multi-person production control according to an embodiment of this application. The blogger may first select content expected to upload, and then click/tap a selection completion control 401 (that is, a control marked as “Complete” in FIG. 4). The selected content is the target content waiting to be produced into the multi-version content. In response to obtaining the target content, a multi-person production control 402 (that is, a control marked as a “Multi-version content settings” in FIG. 4) is displayed.

In the related art, multi-version content is produced and uploaded by a blogger. To reduce difficulty in production and workload of the blogger, and improve a sense of participation of a viewer, in this embodiment of this application, permission that a viewer can participate in producing branch content of multi-version content of a blogger is granted by using a multi-person production control.

“In response to” is configured for representing a condition or a status on which a to-be-performed operation depends. When the condition or the status is satisfied, one or more to-be-performed operations may be real-time or have a set delay. Unless otherwise specified, there is no chronological order between the plurality of to-be-performed operations.

All data (for example, multi-version content and branch content) collected in this application is collected when an object (for example, a user, an institution, or an enterprise) to which the data belongs agrees and gives authorization, and related data needs to be collected, used, and processed according to related laws, regulations, and standards of a related country or region.

S302: Set a multi-version production range for the target content in response to obtaining a trigger operation performed on the multi-person production control.

If the blogger performs a trigger operation on the multi-person production control, it indicates that the blogger grants permission that a viewer can participate in production of branch content of the multi-version content of the blogger. In this case, in response to obtaining the trigger operation performed on the multi-person production control, a multi-version production range for the target content is set.

The trigger operation may be an operation such as clicking/tapping, double-clicking/tapping, or circling for selection. This is not specifically limited in this application. The multi-version production range is a presentation range of a plurality of pieces of branch content. For example, the 1^{st} minute to the 2^{nd} minute of video content is used to present different branch content, and the 1^{st} minute to the 2^{nd} minute is a multi-version production range of the video content. For another example, Chapter 5 to Chapter 10 of text content is used to present different branch content, Chapter 5 to Chapter 10 is a multi-version production range of the text content.

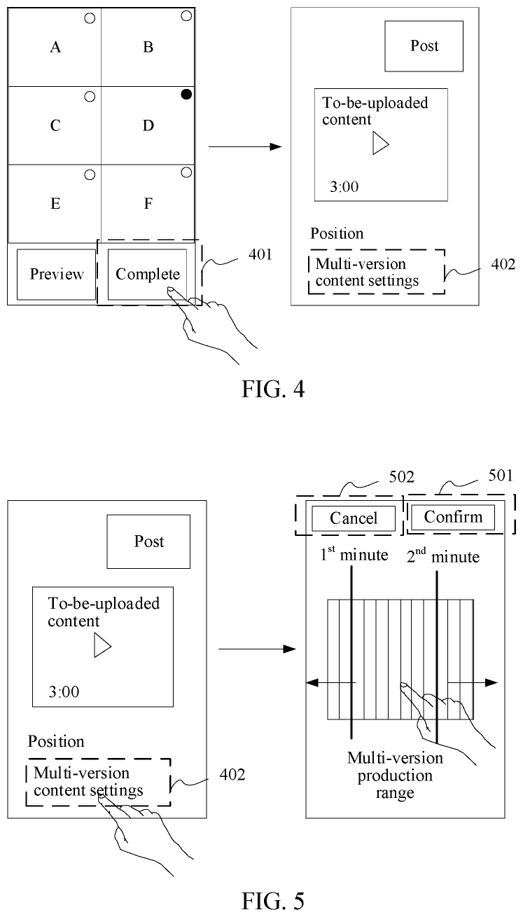

FIG. 5 is a schematic diagram of setting a multi-version production range according to an embodiment of this application. In FIG. 5, an example in which the multi-version content is video content is used. After the blogger performs the trigger operation on the multi-person production control (for example, clicks/taps the multi-person production control 402), the blogger may adjust time of the target content in a manner such as dragging left and right, and set start time (that is, using the 1^{st} minute as a start position) and end time (that is, using the 2^{nd} minute as an end position) of the multi-version production range by using a confirmation control 501 (that is, a control marked as “Confirm” in FIG. 5) and a cancellation control 502 (that is, a control marked as “Cancel” in FIG. 5).

The target content may be complete content, or may be non-complete content. This is not specifically limited in this application. For example, the blogger may produce complete video content, and select a time period of the complete video content as the multi-version production range, so that video content produced by the blogger in this time period may be used as a piece of branch content, or may not be used as a piece of branch content based on selection of the blogger, so that the video content produced by the blogger in this time period is no longer used as a piece of branch content during playback. This is not specifically limited in this application. For another example, the blogger may alternatively produce only the first half of the video content, and use a time period in the second half as the multi-version production range. Both a viewer and the blogger can upload branch content for the multi-version production range.

In an implementation, one or more multi-version production ranges may be set for the same target content. This is not specifically limited in this application.

S303: Upload multi-version content in response to obtaining a confirmation operation performed on the multi-version production range.

The confirmation operation is an operation configured to determine the multi-version production range, and may be an operation such as clicking/tapping, double clicking/tapping, or an interaction. This is not specifically limited in this application. After determining the multi-version production range, the blogger may add a multi-person production identifier to the target content, to obtain multi-version content, to upload the multi-version content.

The multi-version content is content obtained by adding a multi-person production identifier to the target content. The multi-person production identifier is configured for representing that the multi-version content supports presenting a plurality of pieces of branch content in the multi-version production range, and the plurality of pieces of branch content are uploaded by a plurality of account identifiers. For example, the blogger uploads a piece of branch content based on an account of the blogger, and a viewer uploads a piece of branch content based on an account of the viewer, or a plurality of viewers respectively upload a plurality of pieces of branch content based on accounts of the viewers. The account identifier is an identifier configured for identifying an account.

In other words, the multi-version content includes a plurality of pieces of branch content from a plurality of accounts, and the plurality of pieces of branch content are presented in the multi-version production range set by the blogger. Subsequently, based on selection of a viewer, branch content selected by the viewer is presented in the multi-version production range.

In an implementation, the multi-version content may be uploaded, and metadata of the multi-version content may be further uploaded. The metadata includes: the multi-person production identifier of the multi-version content, whether a multi-person production function is enabled for the multi-version content, a start position of the multi-version production range, and an end position of the multi-version production range. Although content may be used as multi-version content, a blogger may not enable a function of uploading branch content by a viewer, which is reflected in that a multi-person production function is not enabled for the multi-version content, that is, the blogger produces the multi-version content alone.

The following describes the metadata of the video content by using an EXtensible Markup Language (XML) as an example.

After the blogger sets the multi-version production range for the target content, metadata is obtained by using an audio/video encoding/decoding tool and a Fast Forward moving picture experts group (FFmpeg), and is added to the target content, to obtain the multi-version content. Specifically, the metadata defined in an xml format is as follows:
<multi_content_video>
   <tag>support_multi_content_video</tag>
   <fragment>
      <params>start_time=123</params>
      <params>end_time=456</params>
   </fragment>
</multi_content_video>

The tag <multi_content_video> is the multi-person production identifier. A field support_multi_content_video with the tag <tag> represents that the multi-person production function is enabled for the multi-version content, and if there is no such a field, it represents that the multi-person production function is not enabled for the multi-version content. The tag <fragment> is configured for representing one multi-version production range, so that each multi-version production range is distinguished by using the tag <fragment>. The tag <params> wraps start_time and end_time separately, where start_time is a start position, for example, start time, of the multi-version production range, and end_time is an end position, for example, end time, of the multi-version production range.

After the metadata is defined, an ffmpeg command: ffmpeg -i input.mp4-metadata:s:v:0
xml=“<multi_content_video><tag>support_multi_content_video</tag><params>start_time=123</params><params>end_time=456</params></multi_content_video >”-codec copy ouput. mp4 is used to add the metadata to the video.

The ffmpeg is configured to invoke an FFmpeg command-line tool. -i input.mp4 is configured to specify that an input file is an i^{th} input.mp4.-metadata:s:v:0 is configured to specify a stream of a to-be-modified video (metadata).s:v:0 represents that the first video stream is selected. s represents a stream, v represents a video, and 0 represents an index.
xml=“<multi_content_video><tag>support_multi_content_video</tag><params>start_time=123</params><params>end_time=456</params></multi_content_video>” is configured for user-defined metadata that is to be added. The metadata is an XML string including one multi_content_video tag and a plurality of params tags.-codec copy is configured to instruct the FFmpeg not to re-encode video and audio streams during processing, but directly copy the video and audio streams. This keeps original quality and increases a processing speed. output.mp4 is configured to specify that an output file is output.mp4.

In addition, if a plurality of multi-version production ranges are set for the target content, metadata defined in the xml format is as follows:
<multi_content_video>
   <tag>support_multi_content_video</tag>
   <fragment>
      <params>start_time=123</params>
      <params>end_time=456</params>
   </fragment>
   <fragment>
      <params>start_time=321</params>
      <params>end_time=654</params>
   </fragment>
   <fragment>
      <params>start_time=312</params>
      <params>end_time=645</params>
   </fragment>
</multi_content_video>

Therefore, the metadata is added to the target content, where the metadata may include the multi-person production identifier and the start position and the end position of the multi-version production range, and may include whether a multi-person production function is enabled for the multi-version content, so as to distinguish between multi-version content produced by the blogger alone and multi-version content obtained by granting permission by the blogger to a viewer to upload branch content, which is convenient and fast.

In an implementation, the metadata of the multi-version content may be further encrypted to obtain encrypted metadata of the multi-version content, and the multi-version content and the encrypted metadata of the multi-version content are uploaded. In other words, compared with directly uploading the metadata, uploading the metadata subjected to encryption, that is, the encrypted metadata, can prevent viewing of multi-version content being affected caused by tampering with data, thereby improving security of a platform.

It can be seen from the foregoing technical solutions that, after target content is obtained, a multi-person production control is displayed. The multi-person production control is configured to grant permission to another account to upload branch content for the target content. If a trigger operation performed on the multi-person production control is obtained, a multi-version production range for the target content, that is, a part of the target content is configured to present a plurality of pieces of branch content, is set. After the multi-version production range has been set, the multi-version content is uploaded. The multi-version content is target content having a multi-person production identifier, the multi-person production identifier is configured for representing that the target content supports presenting a plurality of pieces of branch content in a multi-version production range, and the plurality of pieces of branch content are obtained by uploading based on a plurality of accounts.

Therefore, by using the multi-person production control, permission to upload branch content for the target content may be granted to another account, that is, a plurality of pieces of branch content for the same multi-version content may be produced and uploaded by a plurality of creators, thereby reducing production difficulty and workload of each creator.

In an implementation, in a process of uploading the multi-version content, the blogger may further set which viewers can participate in uploading branch content. For details, refer to A1 and A2.

A1: Display a user permission control in response to obtaining the confirmation operation performed on the multi-version production range.

The user permission control is configured to select a user having permission to upload branch content.

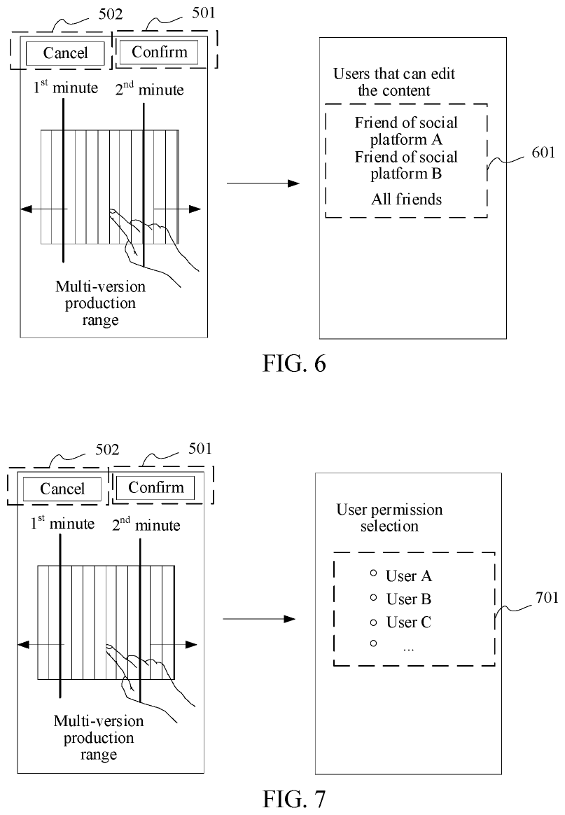

FIG. 6 is a schematic diagram of a user permission control according to an embodiment of this application. After the blogger successfully sets the multi-version production range, a user permission control 601 is displayed. In FIG. 6, a control marked as “Friend of social platform A”, a control marked as “Friend of social platform B”, and a control marked as “All friends” are all user permission controls 601. A user having permission to upload branch content may be selected by using different user permission controls 601, which is convenient and fast.

FIG. 7 is a schematic diagram of a user permission control according to an embodiment of this application. After the blogger successfully sets the multi-version production range, a user permission control 701 is displayed. In FIG. 7, each user waiting to be selected is a user permission control 701. After the blogger selects a user having permission to upload branch content from a plurality of users, a first account identifier set having uploading permission is obtained in a more targeted manner in response to a trigger operation performed on the user permission control.

A2: Upload the multi-version content after the first account identifier set is determined by using the user permission control.

The blogger may select, by using the user permission control, a user having permission to upload branch content. Account identifiers of users having permission to upload branch content for the multi-version content form the first account identifier set.

The uploaded multi-version content has correspondence with the first account identifier set. For example, the multi-version content carries the first account identifier set, so as to subsequently determine, based on the first account identifier set corresponding to the multi-version content, which users can upload the branch content for the multi-version content.

Therefore, a user having permission to upload branch content can be selected by using the user permission control, so that a specific user (that is, a user indicated by an account identifier included in the first account identifier set) can be interacted with in a targeted manner, and content quality of the multi-version content can be ensured by setting the specific user, to prevent excessive useless branch content from affecting the content quality of the multi-version content.

In an implementation, a user having permission to upload branch content may be set in the manners A1 and A2, that is, set before the multi-version content is uploaded, and may be further set in manners B1 and B2, that is, after the multi-version content is uploaded, the user permission control is displayed, to be specific, after the blogger uploads the multi-version content, which viewers can participate in uploading of branch content may be further set.

B1: Display a user permission control in response to a selection operation performed on target multi-version content.

The target multi-version content is one of a plurality of pieces of multi-version content.

FIG. 8 is a schematic diagram of a user permission control according to an embodiment of this application. After the blogger selects one piece of multi-version content from a plurality of pieces of multi-version content uploaded by the blogger as target multi-version content, for example, multi-version content 2 is selected as the target multi-version content in FIG. 8, and a user permission control 701 is displayed.

B2: Establish correspondence between the target multi-version content and a second account identifier set after the second account identifier set is determined by using the user permission control.

For details, refer to A1 and A2. Details are not described herein again. Account identifiers of users having permission to upload branch content for the target multi-version content form the second account identifier set.

In an implementation, if one piece of multi-version content has a plurality of multi-version production ranges, different multi-version production ranges correspond to different branch content, so that different uploading permission may be set based on the different multi-version production ranges, that is, permission for users to upload branch content is subdivided, thereby satisfying a diversity requirement of the blogger.

Therefore, the user permission control may be displayed after the multi-version content is uploaded, so that a user having permission to upload branch content can be set by using the user permission control, thereby satisfying a diversity requirement of the blogger in a plurality of setting manners.

In an implementation, in this embodiment of this application, after the user having permission to upload branch content is set, an uploading prompt function is further provided. For details, refer to C1 and C2.

C1: Display a message transmitting control after the first account identifier set is determined by using the user permission control.

The message transmitting control is configured to transmit, to an account identifier included in the first account identifier set, a prompt of uploading the branch content for the multi-version content.

C2: Transmit, to the account identifier included in the first account identifier set in response to obtaining a trigger operation performed on the message transmitting control, a prompt of uploading the branch content for the multi-version content.

In an implementation, after the first account identifier set is determined by using the user permission control, a prompt of uploading the branch content for the multi-version content may be transmitted to the user having uploading permission, and a multi-version production range in the multi-version content may be sent to the user having the uploading permission to upload branch content.

Therefore, by setting the message transmitting control, the prompt may be transmitted to the user having the uploading permission based on intention of the blogger, thereby enhancing experience of the blogger, and helping rapidly complete production of a plurality of pieces of branch content for the multi-version content, improving production efficiency.

In an implementation, a prompt may be transmitted to a user having the uploading permission by using the message transmitting control after the first account identifier set is determined by using the user permission control, and a prompt may alternatively be directly transmitted to a user having the uploading permission, which is convenient and fast.

In an implementation, the prompt transmitted to the user having the uploading permission may be an internal message of a presentation platform of multi-version content, and the user can view the prompt after logging in to the platform; or the prompt may be an external message across platforms. For example, the prompt is transmitted to the user by using a platform that is not a presentation platform of multi-version content such as an SMS message or a social platform.

In an implementation, the blogger may further set a maximum uploading quantity of pieces of branch content for the multi-version content. For details, refer to D1 and D2.

D1: Display a branch content quantity control in response to obtaining the confirmation operation performed on the multi-version production range.

A branch content quantity control is configured to set a maximum uploading quantity of a plurality of pieces of branch content included in the multi-version content, that is, a maximum quantity of pieces of branch content displayed in one multi-version production range, or a maximum quantity of pieces of branch content that can be uploaded by users at most for the same multi-version production range of the same multi-version content. For example, the maximum uploading quantity may be determined by inputting a number, using a drop-down list, or the like. This is not specifically limited in this application.

In an implementation, in response to obtaining the confirmation operation performed on the multi-version production range, a branch content quantity control and a user permission control are displayed.

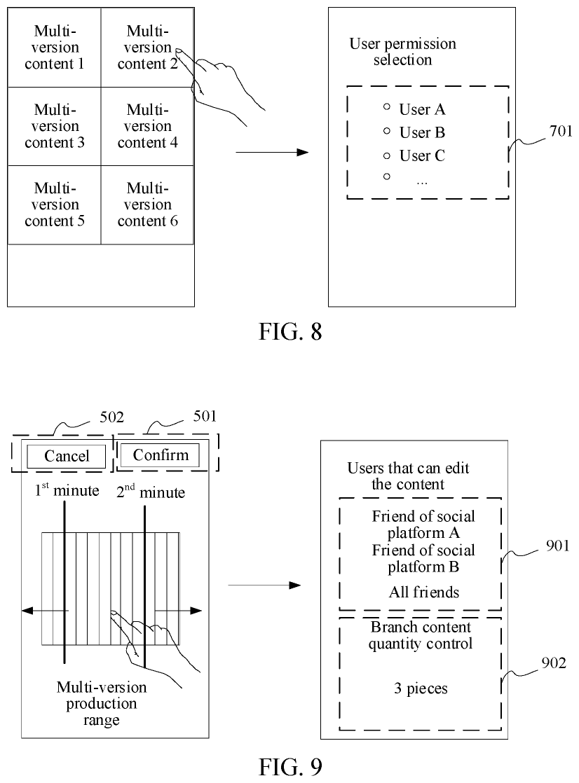

FIG. 9 is a schematic diagram of displaying a branch content quantity control and a user permission control according to an embodiment of this application. In FIG. 9, a branch content quantity control 902 and a user permission control 901 are displayed on the same page. The blogger may set, in the same page, users having the uploading permission and the maximum uploading quantity, which is convenient and fast.

In an implementation, a maximum uploading quantity may be further set for pieces of branch content of one piece of multi-version content (that is, a maximum uploading quantity specified by the platform) by the presentation platform of the multi-version content, so that a maximum quantity (that is, a maximum uploading quantity set by the blogger) set by the blogger by using the branch content quantity control for pieces of branch content that can be uploaded by users at most for the multi-version content of the blogger is less than the maximum uploading quantity set for pieces of branch content of one piece of multi-version content by the presentation platform of the multi-version content, that is, the maximum uploading quantity set by the blogger needs to be less than the maximum uploading quantity specified by the platform, so as to reduce storage pressure of the presentation platform of the multi-version content.

D2: Upload the multi-version content after the maximum uploading quantity of pieces of branch content is determined by using the branch content quantity control.

A quantity of the plurality of pieces of branch content of the multi-version content is less than or equal to the maximum uploading quantity set by the blogger.

Because people usually pay more attention to three to five pieces of content, the blogger may set a quantity of pieces of branch content to five or the like by using the branch content quantity control.

Therefore, by using the branch content quantity control, the blogger may further set, for the multi-version content, a maximum uploading quantity of pieces of branch content included in the multi-version content uploaded by the blogger, preventing subsequent choices of a viewer from being affected due to excessive pieces of branch content while reducing the storage pressure of the presentation platform of the multi-version content, to improve user experience.

After a process in which the blogger uploads the multi-version content and grants permission to a viewer to upload branch content, a manner in which the viewer uploads the branch content is described below.

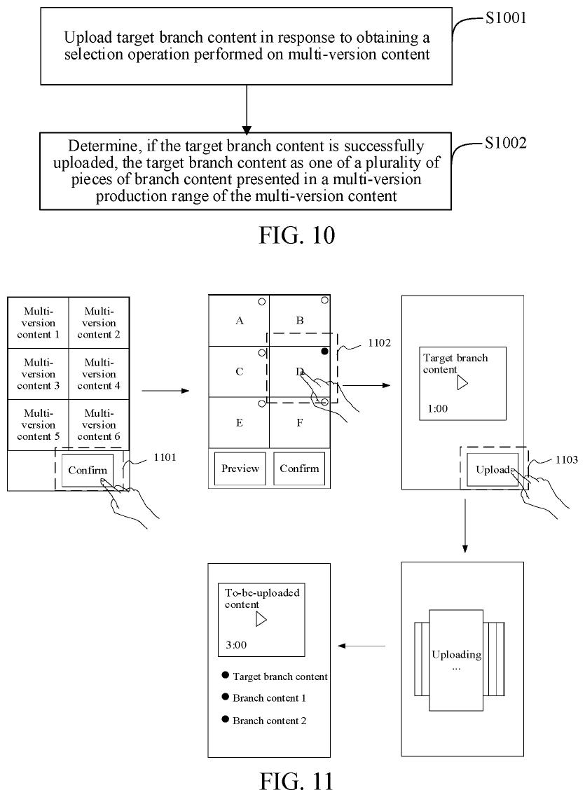

FIG. 10 is a schematic flowchart of a content interaction method according to an embodiment of this application. For ease of description, the following embodiment is still described by using an example in which the content interaction method is performed by a viewer at a terminal device. In this example, the terminal device first receives a message from a blogger. The message includes an identifier of multi-version content, an identifier of a first branch content, and a multi-person production identifier. The multi-person production identifier indicates that the blogger allows presenting a plurality of pieces of branch content in a multi-version production range of the multi-version content. Next, the terminal device displays a graphical user interface on a screen of the terminal device. In some embodiments, the graphical user interface includes a first icon corresponding to the multi-version content, a second icon corresponding to the first branch content, and a multi-version production control corresponding to the multi-person production identifier. As shown in FIG. 10, the content interaction method includes S1001 and S1002.

S1001: Upload target branch content in response to obtaining a selection operation performed on multi-version content. In some embodiments, the terminal device, in response to obtaining a selection operation performed on the multi-version production control, uploads, to a remote server, the target branch content chosen by the viewer from a plurality of candidate branch contents.

The selection operation is an operation configured for selection, and may be an operation such as clicking/tapping, double clicking/tapping, or an interaction. This is not specifically limited in this application.

After a viewer selects multi-version content of which the viewer intends to participate in co-creation, in response to obtaining a trigger operation performed on the multi-version content, the viewer selects and uploads branch content for the multi-version content, that is, target branch content.

FIG. 11 is a schematic diagram of uploading branch content according to an embodiment of this application. In FIG. 11, after the viewer selects, from a plurality of pieces of multi-version content, one piece of multi-version content for which the viewer intends to upload branch content, the multi-version content is selected based on a confirmation control 1101 (for example, a control marked as “Confirm” shown in FIG. 11). Then branch content that the viewer intends to upload is selected, that is, target branch content 1102 (for example, content D shown in FIG. 11), and the target branch content 1102 is uploaded based on an upload control 1103 (for example, a control marked as “Upload” shown in FIG. 11). In addition, secondary confirmation of the target branch content may be further implemented based on a confirmation control (for example, a control marked as “Confirm” shown in FIG. 11) after the target branch content 1102 is selected, to improve accuracy of subsequent uploading.

In an implementation, after logging in to the presentation platform of the multi-version content, the viewer may receive a prompt, transmitted by the presentation platform, that the viewer has permission to upload branch content for a piece of multi-version content. Alternatively, the viewer may receive a prompt, in another social platform transmitted by the presentation platform, that the viewer has permission to upload branch content for a piece of multi-version content. Then, the viewer selects, based on the prompt, the multi-version content for which the viewer has permission to upload branch content, to upload the target branch content in response to the selection operation performed on the multi-version content.

S1002: Determine, after the target branch content is successfully uploaded, the target branch content as one of a plurality of pieces of branch content presented in the multi-version production range of the multi-version content. In some embodiments, the terminal device adds the target branch content as one of the plurality of pieces of branch content presented in the multi-version production range of the multi-version content and adds a third icon corresponding to the first branch content to the graphical user interface on the screen of the terminal device.

If the target branch content is successfully uploaded, the target branch content becomes a piece of branch content of the multi-version content presented in the multi-version production range. Still referring to FIG. 11, the multi-version production range includes three pieces of branch content, which are respectively the target branch content, branch content 1, and branch content 2.

Therefore, when the blogger grants, for the multi-version content, permission to a viewer to upload branch content, the viewer may produce and upload the target branch content. After the uploading succeeds, the target branch content may be used as one of the plurality of pieces of branch content included in the multi-version content, so that the blogger and the viewer produce the multi-version content together, that is, the plurality of pieces of branch content for the same multi-version content may be produced and uploaded by a plurality of creators, thereby reducing production difficulty and workload of each creator.

In an implementation, if one piece of multi-version content includes a plurality of multi-version production ranges, the viewer may select one of the multi-version production ranges to upload the target branch content. For details, refer to E1 and E2.

E1: Display a plurality of multi-version production ranges for the multi-version content in response to obtaining the selection operation performed on the multi-version content.

If one piece of multi-version content includes a plurality of multi-version production ranges, after the selection operation performed by a viewer on the multi-version content, the plurality of multi-version production ranges included in the multi-version content are displayed, and branch content may be uploaded in each multi-version production range.

E2: Upload, in response to a trigger operation performed on a target multi-version production range among the plurality of multi-version production ranges, the target branch content for the target multi-version production range.

The viewer may select one multi-version production range from the plurality of multi-version production ranges. Using an example in which the selected multi-version production range is a target multi-version production range, the viewer may upload target branch content for the target multi-version production range, so as to present the target branch content in the target multi-version production range.

Therefore, if one piece of multi-version content includes a plurality of multi-version production ranges, the plurality of multi-version production ranges for the multi-version content may be displayed, so that the viewer may select one of the plurality of multi-version production ranges to upload the target branch content, which is convenient and fast.

In an implementation, if the blogger sets uploading permission for the multi-version content, only a viewer having the uploading permission can upload the target branch content. For details, refer to F1 to F3.

F1: Obtain an account identifier uploading the target branch content and a first account identifier set having correspondence with the multi-version content.

If the blogger sets the uploading permission for the multi-version content, the multi-version content has correspondence with the first account identifier set having the uploading permission. When a viewer intends to upload the target branch content for the multi-version content, the viewer needs to obtain the account identifier that uploads the target branch content and the first account identifier set having correspondence with the multi-version content, to facilitate subsequent comparison.

F2: If the first account identifier set includes an account identifier the same as the account identifier uploading the target branch content, the account identifier uploading the target branch content has permission to upload branch content for the multi-version content.

An account identifier of the viewer is compared with the first account identifier set. If the account identifier of the viewer is the same as an account identifier in the first account identifier set, that is, the first account identifier set includes an account identifier the same as the account identifier uploading the target branch content, the account identifier uploading the target branch content has the permission to upload branch content for the multi-version content.

F3: Upload the target branch content in response to obtaining the selection operation performed on the multi-version content and the account identifier uploading the target branch content having permission to upload the branch content for the multi-version content.

In other words, to determine whether the target branch content can be uploaded, whether an account identifier uploading the target branch content has the uploading permission further needs to be determined.

Therefore, after setting the uploading permission for the multi-version content, the blogger can determine, according to account identifiers of viewers, whether each viewer has the uploading permission. That is, only a viewer having the uploading permission can upload branch content produced by the viewer, so that the blogger can interact with a specific user in a targeted manner, and can further ensure content quality of the multi-version content, to prevent excessive useless branch content from affecting the content quality of the multi-version content.

In an implementation, the viewer may be a user that is verified to have permission to upload branch content for the multi-version content in a process of watching the multi-version content, so that the viewer may be reminded of the uploading permission when the multi-version production range of the multi-version content is presented. Therefore, the viewer may upload the target branch content for the multi-version content.

In an implementation, if the blogger sets the maximum uploading quantity for the multi-version content, the viewer can upload the target branch content only after a quantity of pieces of the branch content is less than the maximum uploading quantity. For details, refer to G1 and G2.

G1: Obtain the maximum uploading quantity for the multi-version content.

The maximum uploading quantity for the multi-version content is a maximum quantity of pieces of uploaded branch content for the multi-version content.

G2: Determine that the target branch content is successfully uploaded if a quantity of pieces of historical branch content included in the multi-version content is less than the maximum uploading quantity.

The historical branch content included in the multi-version content is branch content uploaded for the multi-version content before the target branch content. If the quantity of pieces of historical branch content included in the multi-version content is less than the maximum uploading quantity, it indicates that branch content can be further uploaded for the multi-version branch content, and the target branch content is successfully uploaded.

Therefore, if the blogger sets the maximum uploading quantity for the multi-version content, whether branch content can continue to be uploaded for the multi-version content, that is, whether the target branch content can be uploaded successfully, needs to be determined based on the quantity of pieces of historical branch content and the maximum uploading quantity. Therefore, while the storage pressure of the presentation platform of the multi-version content is reduced, subsequent selection of a viewer is prevented from being affected by a large amount of branch content, thereby enhancing user experience.

In an implementation, an interaction process between a terminal device and a server is described below.

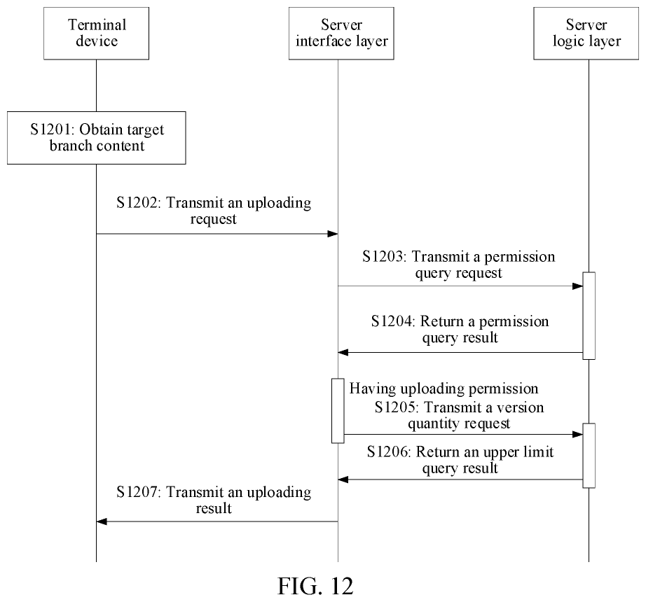

FIG. 12 is a signaling interworking diagram of uploading target branch content according to an embodiment of this application.

S1201: A terminal device obtains target branch content.

S1202: The terminal device transmits an uploading request to a server interface layer.

The server includes the server interface layer and a server logic layer.

The uploading request includes an identifier of the multi-version content corresponding to the target branch content and an account identifier configured to upload the target branch content.

S1203: The server interface layer sends a permission query request to the server logic layer.

The permission query request includes the identifier of the multi-version content corresponding to the target branch content and the account identifier configured to upload the target branch content.

S1204: The server logic layer returns a permission query result to the server interface layer.

The permission query result is configured for representing whether there is uploading permission. The server logic layer obtains the first account identifier set having the uploading permission based on the identifier of the multi-version content corresponding to the target branch content. If the first account identifier set includes an account identifier uploading the target branch content, the first account identifier set has the uploading permission; otherwise, the first account identifier set does not have the uploading permission.

S1205: The server interface layer transmits a version quantity request to the server logic layer if determining, based on the permission query result, that the first account identifier set has the uploading permission.

The version quantity request is configured for querying for the maximum uploading quantity of the multi-version content.

S1206: The server logic layer returns an upper limit query result to the server interface layer.

The upper limit query result is configured for identifying whether a quantity of pieces of the historical branch content included in the multi-version content reaches the maximum uploading quantity.

S1207: The server interface layer transmits an uploading result to the terminal device.

The uploading result is configured for identifying whether a viewer can upload the target branch content.

In an implementation, since not all branch content uploaded by viewers attracts other viewers, to ensure the quality of multi-version content, whether to retain branch content may be determined based on a popularity. For details, refer to H1 to H3.

H1: Determine a popularity of each piece of historical branch content if the quantity of pieces of historical branch content included in the multi-version content is equal to the maximum uploading quantity.

If the quantity of pieces of historical branch content included in the multi-version content is equal to the maximum uploading quantity, it indicates that the quantity pieces of branch content that has been uploaded for the multi-version content already satisfies the maximum uploading quantity. In this case, branch content such as the target branch content can no longer be uploaded.

The popularity is configured to represent a popular degree of various pieces of content, such as a number of views and a number of shares. For another example, watching time may be set for a newly uploaded piece of branch content based on a ratio of uploading time to the number of views.

H2: Determine, if the popularity of each piece of historical branch content satisfies a popularity condition, that the uploading of the target branch content fails.

If the popularity of each piece of historical branch content satisfies the popularity condition, it indicates that each piece of historical branch content that has been uploaded is popular. In this case, the target branch content is no longer uploaded.

The popularity condition is not specifically limited in this embodiment of this application, and may be set by a person skilled in the art according to an actual requirement.

H3: Delete, if a target popularity among the popularity of each piece of historical branch content does not satisfy the popularity condition, historical branch content corresponding to the target popularity, and determine that the uploading of the target branch content is successful.

The target popularity is one of popularities respectively corresponding to a plurality of pieces of historical branch content. If the target popularity does not satisfy the popularity condition among the popularity of each piece of historical branch content, it indicates that the historical branch content corresponding to the target popularity is not popular, the historical branch content may be deleted, and the target branch content may be uploaded, that is, it is determined that the uploading of the target branch content is successful. Therefore, new branch content is used to replace branch content that is not popular.

In addition, the blogger may further set interaction values of viewers with the blogger, feature values transferred by viewers for the blogger, and the like as benchmarks for sorting. This is not specifically limited in this application.

Therefore, if the quantity of pieces of historical branch content included in the multi-version content is equal to the maximum uploading quantity, whether to retain the historical branch content may be determined based on the popularity. In this way, it is ensured that the historical branch content of the multi-version content is branch content with a high popularity, thereby improving content quality of the multi-version content and enhancing the user experience.

In an implementation, a popularity increase button may be set, to help a viewer improve popularity of the target branch content uploaded by the viewer. For details, refer to I1 and I2.

I1: Display a popularity increase button.

After the target branch content is successfully uploaded, one or more popularity increase buttons may be displayed. The popularity increase button is configured to increase a popularity for uploaded branch content. If there are a plurality of popularity increase buttons, different popularity increase buttons may correspond to different popularity increase policies.

Each popularity increase button corresponds to one policy for increasing a popularity, that is, a popularity increase policy. For example, watching and sharing can improve an intimacy value with an uploader, or transfer a feature value (such as a virtual coin of a presentation platform) by an uploader to a sharer. This is not specifically limited in this application.

I2: Set, in response to obtaining a trigger operation performed on the popularity increase button, a popularity increase policy corresponding to the popularity increase button for the target branch content.

If a viewer (namely, the uploader) uploading the target branch content performs the trigger operation on the popularity increase button, it indicates that the viewer intends to increase a popularity of the target branch content, a popularity increase policy corresponding to the popularity increase button is set for the target branch content, to prevent the target branch content from being deleted due to a low popularity.

Therefore, the popularity increase button is set, to help the viewer improve the popularity of the target branch content uploaded by the viewer, thereby increasing enthusiasm of the viewer and improving interaction with the viewer.

After a manner in which the viewer uploads the branch content is described, viewing of the multi-version content by the viewer is described. For details, refer to S1301 to S1303.

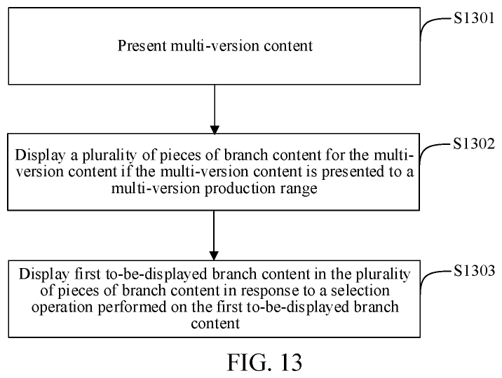

FIG. 13 is a schematic flowchart of a content interaction method according to an embodiment of this application.

S1301: Present multi-version content.

When a viewer selects one piece of multi-version content for viewing, the multi-version content is presented.

S1302: Display a plurality of pieces of branch content for the multi-version content if the multi-version content is presented to a multi-version production range.

If the multi-version content is presented to the multi-version production range, for example, presented to a start position of the multi-version production range, where the multi-version production range is configured for presenting the plurality of pieces of branch content, the plurality of pieces of branch content for the multi-version content are displayed.

For example, if the multi-version content is text content, when a viewer views text content corresponding to the multi-version production range, a plurality of pieces of branch content are displayed. For another example, if the multi-version content is video content, when a viewer watches the video content corresponding to the multi-version production range, a plurality of pieces of branch content are displayed.

If the branch content has extensive content, a content identifier, such as a title or a plot, of the branch content may be displayed. This is not specifically limited in this application.

S1303: Display first to-be-displayed branch content in the plurality of pieces of branch content in response to a selection operation performed on the first to-be-displayed branch content.

The user can view only one of the plurality of pieces of branch content, and in response to a selection operation performed on first to-be-displayed branch content in the plurality of pieces of branch content, the first to-be-displayed branch content is displayed.

Therefore, when the multi-version content is presented to the start position of the multi-version production range, the plurality of pieces of branch content corresponding to the multi-version production range are presented, so that the viewer may select one piece of branch content from the plurality of pieces of branch content as the first to-be-displayed branch content, so as to present the first to-be-displayed branch content.

In an implementation, an interaction process between a terminal device and a server is described below.

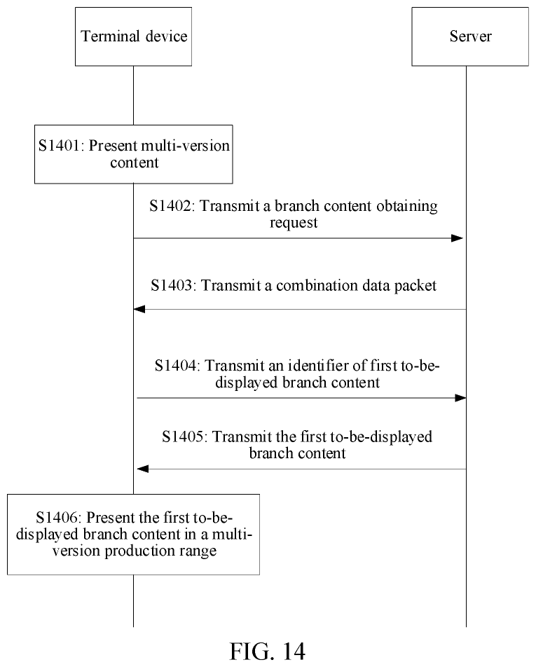

FIG. 14 is a signaling interworking diagram of viewing multi-version content according to an embodiment of this application.

S1401: A terminal device presents multi-version content.

S1402: The terminal device transmits a branch content obtaining request to a server.

The branch content obtaining request includes an identifier of the multi-version content.

S1403: The server transmits a combination data packet to the terminal device.

The server determines the combination data packet according to the identifier of the multi-version content. The combination data packet includes a plurality of pieces of preview content respectively corresponding to the plurality of pieces of branch content.

S1404: The terminal device transmits an identifier of first to-be-displayed branch content to the server.

The terminal device displays the plurality of pieces of preview content respectively corresponding to the plurality of pieces of branch content. After the user selects one branch of interest, that is, the first to-be-displayed branch content, according to the plurality of pieces of preview content, the terminal device transmits the identifier of the first to-be-displayed branch content to the server.

S1405: The server transmits the first to-be-displayed branch content to the terminal device.

The server determines the first to-be-displayed branch content according to the identifier of the first to-be-displayed branch content and transmits the first to-be-displayed branch content to the terminal device.

S1406: The terminal device presents the first to-be-displayed branch content in a multi-version production range.

In an implementation, to help the viewer to select branch content that the viewer intends to view, the preview content may be provided for the plurality of pieces of branch content. When the multi-version content is presented to the multi-version production range, in addition to the plurality of pieces of branch content for the multi-version content are displayed, the plurality of pieces of preview content respectively corresponding to the plurality of pieces of branch content for the multi-version content may be displayed. In response to a trigger operation performed on the first to-be-displayed branch content in the plurality of pieces of branch content, the first to-be-displayed branch content is displayed in the multi-version production range.

The preview content is configured for describing the branch content. Using video content as an example, preview content may be content of first several frames of branch content, plot summary text, or the like. This is not specifically limited in this application.

Therefore, the plurality of pieces of branch content are presented in a form of preview content, so that it is convenient for the viewer to quickly select, from the plurality of pieces of branch content, branch content that the viewer intends to watch, thereby enhancing the user experience.

Displaying the plurality of pieces of preview content respectively corresponding to the plurality of pieces of branch content for the multi-version content is described below by using an example in which the multi-version content is video content. For details, refer to J1 to J3.

The multi-version content includes second to-be-displayed branch content and third to-be-displayed branch content. The second to-be-displayed branch content and the third to-be-displayed branch content are different branch content. The first to-be-displayed branch content may be the second to-be-displayed branch content, or may be the third to-be-displayed branch content, or may be neither. This is not specifically limited in this application.

J1: Obtain a combination data packet when the multi-version content is displayed to the multi-version production range.

The combination data packet is a data packet obtained by jointly encoding first n video frames of the second to-be-displayed branch content and first m video frames of the third to-be-displayed branch content, m being a positive integer, and n being a positive integer.

That is, first several video frames of the plurality of pieces of branch content are jointly encoded into the same data packet, to obtain the combination data packet. The combination data packet is obtained when the multi-version content is displayed to the start position of the multi-version production range, so as to display the preview content.

J2: Decode the combination data packet, to obtain the first n video frames of the second to-be-displayed branch content and the first m video frames of the third to-be-displayed branch content.

An encoding mode and a decoding mode are not specifically limited in this embodiment of this application, and may be set by a person skilled in the art according to an actual requirement.

J3: Display the first n video frames of the second to-be-displayed branch content and the first m video frames of the third to-be-displayed branch content.

The preview content includes the first n video frames of the second to-be-displayed branch content and the first m video frames of the third to-be-displayed branch content.

Therefore, when the multi-version content is video content, the first several video frames of each piece of branch content may be encoded into the same combination data packet, so that the first several video frames respectively corresponding to the various pieces of branch content may be obtained based on once encoding and once decoding, and are quickly presented to the viewer, to achieve an effect of immediately opening the various branch content, thereby enhancing the user experience.

In an implementation, when the first n video frames of the second to-be-displayed branch content and the first m video frames of the third to-be-displayed branch content are displayed, one of the second to-be-displayed branch content or the third to-be-displayed branch content may be used as a recommended content and the other may be used as a non-recommended content. Therefore, video frames of the recommended branch content and video frames of the non-recommended branch content are displayed, and audio of the recommended branch content is played. That is, the video frames of the plurality of pieces of branch content are displayed at the same time, but only the audio of the recommended content is played, thereby avoiding affecting watching experience of the viewer.

A manner of determining the recommended content is not specifically limited in this embodiment of this application. For example, the branch content with a highest popularity is used as the recommended content, or the branch content produced by the blogger is used as the recommended content. This is not specifically limited in this application.

Therefore, one of the plurality of pieces of branch content is used as the recommended content, and the remaining branch content is used as the non-recommended content, so that when the preview content of the plurality of pieces of branch content is displayed, the first several video frames of all the branch content are displayed, and only the audio of the recommended content is played. This avoids affecting watching experience of the viewer.

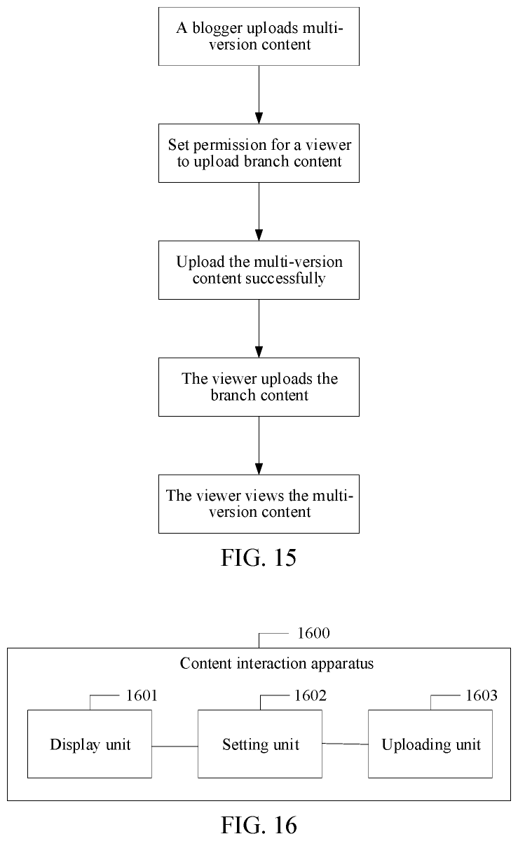

In this way, this application describes a blogger uploading multi-version content and granting permission to a viewer to upload branch content, a manner in which a viewer uploads branch content, and a manner in which a viewer views multi-version content. The following is described below with reference to FIG. 15.

FIG. 15 is a schematic diagram of a content interaction method according to an embodiment of this application. FIG. 15 includes a blogger uploading multi-version content, setting permission for a viewer to upload branch content, uploading the multi-version content successfully, the viewer uploading the branch content, and the viewer viewing the multi-version content.

For the blogger uploading the multi-version content, refer to S301 to S303. For setting permission for the viewer to upload branch content, refer to A1 and A2. For the viewer uploading the branch content, refer to S1001 and S1002. For the viewer viewing the multi-version content, refer to S1301 to S1303.

For the content interaction method described above, this application further provides a corresponding content interaction apparatus, so that the content interaction method can be applied and implemented in practice.

FIG. 16 is a schematic structural diagram of a content interaction apparatus according to an embodiment of this application. As shown in FIG. 16, a content interaction apparatus 1600 includes: a display unit 1601, a setting unit 1602, and an uploading unit 1603.

The display unit 1601 is configured to display a multi-person production control in response to obtaining target content; the setting unit 1602 is configured to set a multi-version production range for the target content in response to obtaining a trigger operation performed on the multi-person production control; and
the uploading unit 1603 is configured to upload multi-version content in response to obtaining a confirmation operation performed on the multi-version production range, the multi-version content being content obtained by adding a multi-person production identifier to the target content, the multi-person production identifier being configured for representing that the multi-version content supports presenting a plurality of pieces of branch content in the multi-version production range, and the plurality of pieces of branch content being obtained by uploading by a plurality of account identifiers.

In an implementation, the uploading unit 1603 is specifically configured to:
display a user permission control in response to obtaining the confirmation operation performed on the multi-version production range; and
upload the multi-version content after a first account identifier set is determined by using the user permission control, an account identifier included in the first account identifier set having permission to upload branch content for the multi-version content, and the multi-version content having correspondence with the first account identifier set.

In an implementation, the content interaction apparatus 1600 further includes a message unit, configured to:
display a message transmitting control after the first account identifier set is determined by using the user permission control; and
transmit, to the account identifier included in the first account identifier set in response to obtaining a trigger operation performed on the message transmitting control, a prompt of uploading the branch content for the multi-version content.

In an implementation, the uploading unit 1603 is specifically configured to:
display a branch content quantity control in response to obtaining the confirmation operation performed on the multi-version production range; and
upload the multi-version content after a maximum uploading quantity is determined for the plurality of pieces of branch content by using the branch content quantity control, a quantity of the plurality of pieces of branch content being less than or equal to the maximum uploading quantity.

In an implementation, the uploading unit 1603 is specifically configured to: upload the multi-version content and metadata of the multi-version content, the metadata including: the multi-person production identifier of the multi-version content, whether a multi-person production function is enabled for the multi-version content, a start position of the multi-version production range, and an end position of the multi-version production range.

In an implementation, the uploading unit 1603 is specifically configured to:
encrypt the metadata of the multi-version content, to obtain encrypted metadata of the multi-version content; and
upload the multi-version content and the encrypted metadata of the multi-version content.

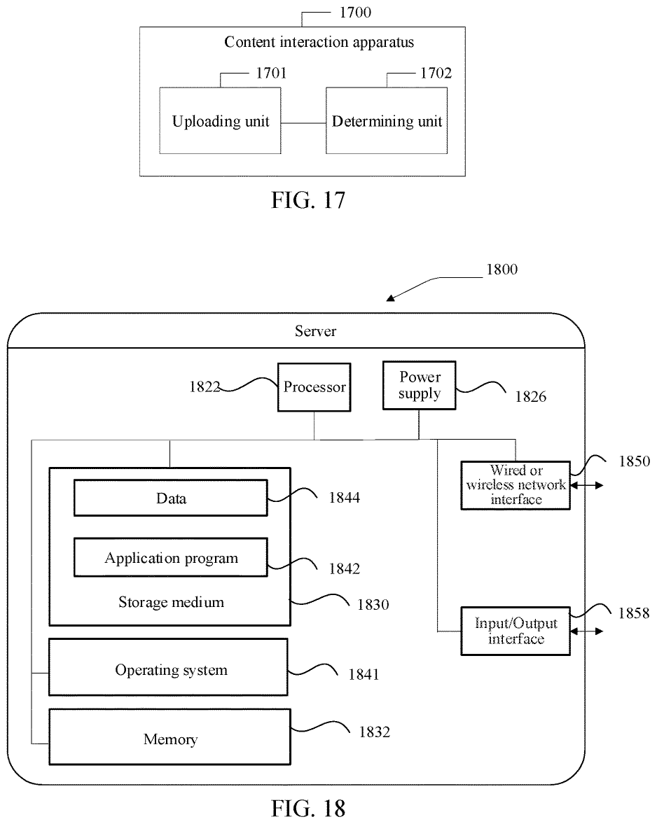

FIG. 17 is a schematic structural diagram of a content interaction apparatus according to an embodiment of this application. As shown in FIG. 17, a content interaction apparatus 1700 includes an uploading unit 1701 and a determining unit 1702.

The uploading unit 1701 is configured to upload target branch content in response to obtaining a selection operation performed on multi-version content, the multi-version content being content having a multi-person production identifier, and the multi-person production identifier being configured for representing that the multi-version content supports presenting a plurality of pieces of branch content in a multi-version production range; and
the determining unit 1702 is configured to determine, if the target branch content is successfully uploaded, the target branch content as one of a plurality of pieces of branch content presented in the multi-version production range of the multi-version content.

In an implementation, the content interaction apparatus 1700 further includes a branch selection unit, configured to:
present the multi-version content;
display preview content of various pieces of branch content when the multi-version content is presented to the multi-version production range; and
display, in response to a trigger operation performed on first to-be-displayed branch content in the plurality of pieces of branch content, the first to-be-displayed branch content in the multi-version production range.

In an implementation, if the multi-version content is video content, the multi-version content includes second to-be-displayed branch content and third to-be-displayed branch content, and the second to-be-displayed branch content and the third to-be-displayed branch content are different branch content, the branch selection unit is specifically configured to:
obtain a combination data packet when the multi-version content is displayed to the multi-version production range, the combination data packet being a data packet obtained by jointly encoding first n video frames of the second to-be-displayed branch content and first m video frames of the third to-be-displayed branch content, m being a positive integer, and n being a positive integer;
decode the combination data packet, to obtain the first n video frames of the second to-be-displayed branch content and the first m video frames of the third to-be-displayed branch content; and
display the first n video frames of the second to-be-displayed branch content and the first m video frames of the third to-be-displayed branch content, the preview content including the first n video frames of the second to-be-displayed branch content and the first m video frames of the third to-be-displayed branch content.

In an implementation, the branch selection unit is specifically configured to:
determine recommended branch content and non-recommended branch content from the second to-be-displayed branch content and the third to-be-displayed branch content, the recommended branch content and the non-recommended branch content being different branch content; and
display the video frames of the recommended branch content and the video frames of the non-recommended branch content, and play audio of the recommended branch content.

In an implementation, the uploading unit 1701 is specifically configured to: display a plurality of multi-version production ranges for the multi-version content in response to obtaining the selection operation performed on the multi-version content; and
upload, in response to a trigger operation performed on a target multi-version production range among the plurality of multi-version production ranges, the target branch content for the target multi-version production range.

In an implementation, the content interaction apparatus 1700 further includes a permission unit, configured to:
obtain an account identifier uploading the target branch content and a first account identifier set having correspondence with the multi-version content,
if the first account identifier set includes an account identifier the same as the account identifier uploading the target branch content, determining that the account identifier uploading the target branch content has permission to upload branch content for the multi-version content; and
the uploading unit 1701 is specifically configured to:
upload the target branch content in response to obtaining the selection operation performed on the multi-version content and the account identifier uploading the target branch content having permission to upload branch content for the multi-version content.

In an implementation, the content interaction apparatus 1700 further includes a quantity unit, configured to:
obtain a maximum uploading quantity for the multi-version content; and
determine that the uploading of the target branch content is successful if a quantity of pieces of historical branch content included in the multi-version content is less than the maximum uploading quantity, the historical branch content being branch content uploaded before the target branch content.

In an implementation, the quantity unit is further configured to:
determine a popularity of each piece of historical branch content if the quantity of pieces of historical branch content included in the multi-version content is equal to the maximum uploading quantity; and
determine, if the popularity of each piece of historical branch content satisfies a popularity condition, that the uploading of the target branch content fails; or
delete, if a target popularity among the popularity of each piece of historical branch content does not satisfy the popularity condition, historical branch content corresponding to the target popularity, and determine that the uploading of the target branch content is successful.

In an implementation, after uploading the target branch content, the content interaction apparatus 1700 further includes a popularity unit, configured to:
display a popularity increase button; and
set, in response to obtaining a trigger operation performed on the popularity increase button, a popularity increase policy corresponding to the popularity increase button for the target branch content.

For the content interaction method described above, this application further provides a corresponding content interaction system, so that the content interaction method can be applied and implemented in practice. The content interaction system includes a first device and a second device.

The first device is configured to perform the method related to the embodiment of S301 to S303; and
the second device is configured to perform the method related to the embodiment of S1001 and S1002.

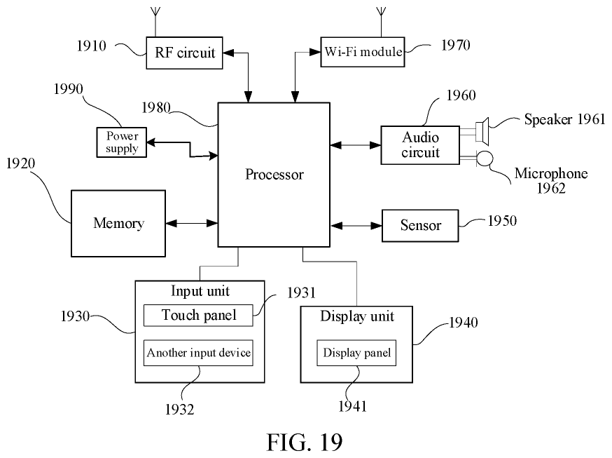

An embodiment of this application further provides a computer device. The computer device may be a server or a terminal device. The following describes the computer device provided in this embodiment of this application from the perspective of hardware materialization. FIG. 18 is a schematic structural diagram of a server, and FIG. 19 is a schematic structural diagram of a terminal device.

FIG. 18 is a schematic structural diagram of a server according to an embodiment of this application. A server 1800 may vary with a configuration or performance, and may include one or more processors 1822, for example, central processing units (CPUs), a memory 1832, and one or more storage media 1830 (for example, one or more mass storage devices) storing an application 1842 or data 1844. The memory 1832 and the storage medium 1830 may provide transitory storage or persistent storage. A program stored in the storage medium 1830 may include one or more modules (not shown in the figure), and each module may include a series of instruction operations on the server. Further, the processor 1822 may be configured to communicate with the storage medium 1830, and perform, on the server 1800, the series of instruction operations in the storage medium 1830.

The server 1800 may further include one or more power supplies 1826, one or more wired or wireless network interfaces 1850, one or more input/output interfaces 1858, and/or one or more operating systems 1841, such as Windows Server™, Mac OS X™, Unix™, Linux™, and FreeBSD™.

The operations performed by the server in the foregoing embodiments may be based on the structure of the server shown in FIG. 18.

The processor 1822 is configured to perform the following operations: displaying a multi-person production control in response to obtaining target content;
setting a multi-version production range for the target content in response to obtaining a trigger operation performed on the multi-person production control; and
uploading multi-version content in response to obtaining a confirmation operation performed on the multi-version production range, the multi-version content being content obtained by adding a multi-person production identifier to the target content, the multi-person production identifier being configured for representing that the multi-version content supports presenting a plurality of pieces of branch content in the multi-version production range, and the plurality of pieces of branch content being obtained by uploading by a plurality of account identifiers.

Alternatively, the processor 1822 is configured to perform the following operations:
uploading target branch content in response to obtaining a selection operation performed on multi-version content, the multi-version content being content having a multi-person production identifier, and the multi-person production identifier being configured for representing that the multi-version content supports presenting a plurality of pieces of branch content in a multi-version production range; and
determining, if the target branch content is successfully uploaded, the target branch content as one of a plurality of pieces of branch content presented in the multi-version production range of the multi-version content.

In some embodiments, the processor 1822 may further perform method operations in any specific implementation of the content interaction method in the embodiments of this application.

FIG. 19 is a schematic structural diagram of a terminal device according to an embodiment of this application. An example in which the terminal device is a smartphone is used for description. FIG. 19 is a block diagram of a partial structure of the smartphone. The smartphone includes: a radio frequency (RF) circuit 1910, a memory 1920, an input unit 1930, a display unit 1940, a sensor 1950, an audio circuit 1960, a wireless fidelity (Wi-Fi) module 1970, a processor 1980, a power supply 1990, and another component. A person skilled in the art may understand that the structure of the smartphone shown in FIG. 19 does not constitute a limitation on the smartphone, and the smartphone may include more or fewer components than those shown in the figure, or some components may be combined, or different component arrangements may be used.

The components of the smartphone are described in detail below with reference to FIG. 19.

The RF circuit 1910 may be configured to receive and transmit signals during an information receiving and transmitting process or a call process. Specifically, the RF circuit 1910 receives downlink information from a base station, and then delivers the downlink information to the processor 1980 for processing. In addition, related uplink data is transmitted to the base station.

The memory 1920 may be configured to store a software program and a module, and the processor 1980 implements various function applications of the smartphone and performs data processing by running the software program and the module stored in the memory 1920.

The input unit 1930 may be configured to receive inputted numeral or character information, and generate key signal input related to user setting and function control of the smartphone. Specifically, the input unit 1930 may include a touch panel 1931 and another input device 1932. The touch panel 1931, also referred to as a touchscreen, can collect a touch operation of a user on or near the touch panel, and drive a corresponding connection apparatus according to a preset program. In addition to the touch panel 1931, the input unit 1930 may further include the another input device 1932. Specifically, the another input device 1932 may include, but is not limited to, one or more of a physical keyboard, a functional key (for example, a volume control key or a switch key), a track ball, a mouse, a joystick, and the like.

The display unit 1940 may be configured to display information inputted by the user or information provided to the user and various menus of the smartphone. The display unit 1940 may include the display panel 1941. In some embodiments, a liquid crystal display (LCD), an organic light-emitting diode (OLED), or the like may be used to configure the display panel 1941.

The smartphone may further include at least one sensor 1950, for example, an optical sensor, a motion sensor, and another sensor. For other sensors such as a gyroscope, a barometer, a hygrometer, a thermometer, and an infrared sensor that may be configured in the smartphone, details are not described herein.

The audio circuit 1960, a speaker 1961, and a microphone 1962 can provide audio interfaces between the user and the smartphone. The audio circuit 1960 can convert received audio data into an electric signal and transmit the electric signal to the speaker 1961. The speaker 1961 converts the electric signal into a sound signal and outputs the sound signal. Furthermore, the microphone 1962 converts a collected sound signal into an electrical signal. After receiving the electrical signal, the audio circuit 1960 converts the electrical signal into audio data, and after outputting the audio data to the processor 1980 for processing, transmits the audio data to, for example, another smartphone through the RF circuit 1910, or outputs the audio data to the memory 1920 for further processing.

The processor 1980 is a control center of the smartphone, connects various parts of the whole smartphone using various interfaces and lines, and executes various functions of the smartphone and processing data by running or executing software programs and/or modules stored in the memory 1920 and invoking data stored in the memory 1920. In some embodiments, the processor 1980 may include one or more processing units.

The smartphone further includes the power supply 1990 (for example, a battery) for supplying power to various components. Preferably, the power supply may be logically connected to the processor 1980 by using a power management system, thereby implementing functions such as managing charging, discharging, and power consumption by using the power management system.

Although not shown, the smartphone may further include a camera, a Bluetooth module, and the like. Details are not described herein.

In this embodiment of this application, the memory 1920 included in the smartphone may store a computer program, and transmit the computer program to the processor.

The processor 1980 included in the smartphone may perform the content interaction method provided in the foregoing embodiments according to instructions in the computer program.

An embodiment of this application further provides a computer-readable storage medium, configured to store a computer program. The computer program is configured to perform the content interaction method provided in the foregoing embodiments.

An embodiment of this application further provides a computer program product or a computer program. The computer program product or the computer program includes computer instructions. The computer instructions are stored in a computer-readable storage medium. A processor of a computer device reads the computer instructions from the computer-readable storage medium, and executes the computer instructions, to enable the computer device to perform the content interaction method provided in various exemplary implementations of the foregoing aspects.

A person ordinary skill in the art may understand that all or some of the steps of the method embodiments may be implemented by hardware related to program instructions. The program may be stored in a computer-readable storage medium. When the program is executed, the steps of the method embodiments are performed. The foregoing storage medium may be at least one of the following media: various media capable of storing computer program, such as a read-only memory (ROM), a random access memory (RAM), a magnetic disk, or an optical disc.

The terms such as “first”, “second”, “third”, and “fourth” (if existing) in the specification and claims of this application and in the accompanying drawings are configured for distinguishing between similar objects and not necessarily configured for describing any particular order or sequence. The terms used in such a way are interchangeable in proper circumstances, so that the embodiments of this application described herein can be implemented in orders except the order illustrated or described herein. In addition, the terms “include” and “correspond to” and any other variants are intended to cover a non-exclusive inclusion. For example, a process, method, system, product, or device that includes a series of steps or units is not necessarily limited to those expressly listed steps or units, but may include other steps or units not expressly listed or inherent to such a process, method, product, or device.

In the embodiments of this application, the term “module” or “unit” refers to a computer program with a predetermined function or a part of the computer program and works, together with other related parts, to achieve a predetermined objective, and may be completely or partially implemented by software, hardware (for example, a processing circuit or a memory) or a combination thereof. Similarly, one processor (or a plurality of processors or memories) may be used to implement one or more modules or units. In addition, each module or unit may be a part of an entire module or unit including functions of the module or the unit.

The embodiments of this specification are all described in a progressive manner. For same or similar parts in the embodiments, refer to these embodiments. Descriptions of each embodiment focus on a difference from other embodiments. Especially, device and system embodiments are similar to the method embodiments, and therefore is described briefly. For related parts, refer to partial descriptions in the method embodiments. The foregoing device and system embodiments are merely exemplary. The units described as separate components may or may not be physically separated, and the components displayed as units may or may not be physical units, and may be located in one place or may be distributed on a plurality of network units. Some or all of the modules may be selected according to actual requirements to achieve the objectives of the solutions of the embodiments. A person of ordinary skill in the art may understand and implement the embodiments without creator efforts.

The foregoing description is merely a specific implementation of this application, and the protection scope of this application is not limited thereto. Any variation or replacement readily figured out by a person skilled in the art within the technical scope disclosed in this application shall fall within the protection scope of this application. In this application, based on the implementations provided in the foregoing aspects, further combinations may be performed to provide more implementations. Therefore, the protection scope of this application shall be subject to the protection scope of the claims.

What is claimed is:

1. A content interaction method between a blogger and a viewer performed by a computer device, the method comprising:
receiving a message from a blogger, wherein the message includes an identifier of multi-version content, an identifier of a first branch content, and a multi-person production identifier, wherein the multi-person production identifier indicates that the blogger allows presenting a plurality of pieces of branch content in a multi-version production range of the multi-version content;
displaying a graphical user interface on a screen of the computer device, the graphical user interface including a first icon corresponding to the multi-version content, a second icon corresponding to the first branch content, and a multi-version production control corresponding to the multi-person production identifier;
in response to obtaining a selection operation performed on the multi-version production control, uploading, to a remote server, target branch content chosen by the viewer from a plurality of candidate branch contents;
after the target branch content is successfully uploaded, adding the target branch content as one of the plurality of pieces of branch content presented in the multi-version production range of the multi-version content; and
adding a third icon corresponding to the first branch content to the graphical user interface on the screen.

2. The method according to claim 1, wherein the method further comprises:
in response to a user selection of the first icon:
presenting the multi-version content;
displaying preview content of the plurality pieces of branch content when the multi-version content is presented to the multi-version production range; and
displaying, in response to a trigger operation performed on first to-be-displayed branch content in the plurality of pieces of branch content, the first to-be-displayed branch content in the multi-version production range.

3. The method according to claim 2, wherein the multi-version content is video content, the multi-version content comprises second to-be-displayed branch content and third to-be-displayed branch content, the displaying preview content of various pieces of branch content when the multi-version content is presented to the multi-version production range comprises:
obtaining, from the remote server, a combination data packet when the multi-version content is displayed to the multi-version production range, the combination data packet being a data packet obtained by jointly encoding first n video frames of the second to-be-displayed branch content and first m video frames of the third to-be-displayed branch content, m being a positive integer, and n being a positive integer;
decoding the combination data packet, to obtain the first n video frames of the second to-be-displayed branch content and the first m video frames of the third to-be-displayed branch content; and
displaying the first n video frames of the second to-be-displayed branch content and the first m video frames of the third to-be-displayed branch content, the preview content comprising the first n video frames of the second to-be-displayed branch content and the first m video frames of the third to-be-displayed branch content.

4. The method according to claim 3, wherein the displaying the first n video frames of the second to-be-displayed branch content and the first m video frames of the third to-be-displayed branch content comprises:
determining recommended branch content and non-recommended branch content from the second to-be-displayed branch content and the third to-be-displayed branch content; and
displaying the video frames of the recommended branch content and the video frames of the non-recommended branch content, and simultaneously playing audio of the recommended branch content.

5. The method according to claim 1, wherein the uploading the target branch content in response to obtaining a selection operation performed on multi-version content comprises:
displaying a plurality of multi-version production ranges for the multi-version content in response to obtaining the selection operation performed on the multi-version content; and
uploading, in response to a trigger operation performed on a target multi-version production range among the plurality of multi-version production ranges, the target branch content for the target multi-version production range.

6. The method according to claim 1, wherein the method further comprises:
obtaining an account identifier of the viewer uploading the target branch content and a first account identifier set having correspondence with the multi-version content,
when the first account identifier set comprises the account identifier of the viewer uploading the target branch content, determining that the account identifier of the viewer uploading the target branch content has permission to upload branch content for the multi-version content; and
uploading the target branch content in response to obtaining the selection operation performed on the multi-version content and the account identifier of the viewer uploading the target branch content having permission to upload branch content for the multi-version content.

7. The method according to claim 1, wherein the method further comprises:
determining that the uploading of the target branch content is successful when a quantity of pieces of historical branch content comprised in the multi-version content is less than a maximum uploading quantity, the historical branch content being branch content uploaded before the target branch content.

8. The method according to claim 7, wherein the method further comprises:
determining a popularity of each piece of historical branch content when the quantity of pieces of historical branch content comprised in the multi-version content is equal to the maximum uploading quantity; and
when the popularity of each piece of historical branch content satisfies a popularity condition, terminating the uploading of the target branch content; and
when a target popularity among the popularity of each piece of historical branch content does not satisfy the popularity condition, causing a deletion of a piece of historical branch content corresponding to the target popularity, and completing the uploading of the target branch content.

9. A computer device, comprising a processor and a memory,
the memory being configured to store a computer program, and transmit the computer program to the processor; and
the processor being configured to perform, according to the computer program, a content interaction method between a blogger and a viewer including:
receiving a message from a blogger, wherein the message includes an identifier of multi-version content, an identifier of a first branch content, and a multi-person production identifier, wherein the multi-person production identifier indicates that the blogger allows presenting a plurality of pieces of branch content in a multi-version production range of the multi-version content;
displaying a graphical user interface on a screen of the computer device, the graphical user interface including a first icon corresponding to the multi-version content, a second icon corresponding to the first branch content, and a multi-version production control corresponding to the multi-person production identifier;
in response to obtaining a selection operation performed on the multi-version production control, uploading, to a remote server, target branch content chosen by the viewer from a plurality of candidate branch contents;
after the target branch content is successfully uploaded, adding the target branch content as one of the plurality of pieces of branch content presented in the multi-version production range of the multi-version content; and
adding a third icon corresponding to the first branch content to the graphical user interface on the screen.

10. The computer device according to claim 9, wherein the method further comprises:
in response to a user selection of the first icon:
presenting the multi-version content;
displaying preview content of the plurality pieces of branch content when the multi-version content is presented to the multi-version production range; and
displaying, in response to a trigger operation performed on first to-be-displayed branch content in the plurality of pieces of branch content, the first to-be-displayed branch content in the multi-version production range.

11. The computer device according to claim 10, wherein the multi-version content is video content, the multi-version content comprises second to-be-displayed branch content and third to-be-displayed branch content, the displaying preview content of various pieces of branch content when the multi-version content is presented to the multi-version production range comprises:
obtaining, from the remote server, a combination data packet when the multi-version content is displayed to the multi-version production range, the combination data packet being a data packet obtained by jointly encoding first n video frames of the second to-be-displayed branch content and first m video frames of the third to-be-displayed branch content, m being a positive integer, and n being a positive integer;
decoding the combination data packet, to obtain the first n video frames of the second to-be-displayed branch content and the first m video frames of the third to-be-displayed branch content; and
displaying the first n video frames of the second to-be-displayed branch content and the first m video frames of the third to-be-displayed branch content, the preview content comprising the first n video frames of the second to-be-displayed branch content and the first m video frames of the third to-be-displayed branch content.

12. The computer device according to claim 11, wherein the displaying the first n video frames of the second to-be-displayed branch content and the first m video frames of the third to-be-displayed branch content comprises:
determining recommended branch content and non-recommended branch content from the second to-be-displayed branch content and the third to-be-displayed branch content; and
displaying the video frames of the recommended branch content and the video frames of the non-recommended branch content, and simultaneously playing audio of the recommended branch content.

13. The computer device according to claim 9, wherein the uploading the target branch content in response to obtaining a selection operation performed on multi-version content comprises:
displaying a plurality of multi-version production ranges for the multi-version content in response to obtaining the selection operation performed on the multi-version content; and
uploading, in response to a trigger operation performed on a target multi-version production range among the plurality of multi-version production ranges, the target branch content for the target multi-version production range.

14. The computer device according to claim 9, wherein the method further comprises:
obtaining an account identifier of the viewer uploading the target branch content and a first account identifier set having correspondence with the multi-version content,
when the first account identifier set comprises the account identifier of the viewer uploading the target branch content, determining that the account identifier of the viewer uploading the target branch content has permission to upload branch content for the multi-version content; and
uploading the target branch content in response to obtaining the selection operation performed on the multi-version content and the account identifier of the viewer uploading the target branch content having permission to upload branch content for the multi-version content.

15. The computer device according to claim 9, wherein the method further comprises:
determining that the uploading of the target branch content is successful when a quantity of pieces of historical branch content comprised in the multi-version content is less than a maximum uploading quantity, the historical branch content being branch content uploaded before the target branch content.

16. The computer device according to claim 15, wherein the method further comprises:
determining a popularity of each piece of historical branch content when the quantity of pieces of historical branch content comprised in the multi-version content is equal to the maximum uploading quantity; and
when the popularity of each piece of historical branch content satisfies a popularity condition, terminating the uploading of the target branch content; and
when a target popularity among the popularity of each piece of historical branch content does not satisfy the popularity condition, causing a deletion of a piece of historical branch content corresponding to the target popularity, and completing the uploading of the target branch content.

17. A non-transitory computer-readable storage medium storing a computer program, the computer program, when executed by a processor of a computer device, causing the computer device to perform a content interaction method between a blogger and a viewer including:
receiving a message from a blogger, wherein the message includes an identifier of multi-version content, an identifier of a first branch content, and a multi-person production identifier, wherein the multi-person production identifier indicates that the blogger allows presenting a plurality of pieces of branch content in a multi-version production range of the multi-version content;
displaying a graphical user interface on a screen of the computer device, the graphical user interface including a first icon corresponding to the multi-version content, a second icon corresponding to the first branch content, and a multi-version production control corresponding to the multi-person production identifier;
in response to obtaining a selection operation performed on the multi-version production control, uploading, to a remote server, target branch content chosen by the viewer from a plurality of candidate branch contents;
after the target branch content is successfully uploaded, adding the target branch content as one of the plurality of pieces of branch content presented in the multi-version production range of the multi-version content; and
adding a third icon corresponding to the first branch content to the graphical user interface on the screen.

18. The non-transitory computer-readable storage medium according to claim 17, wherein the method further comprises:
in response to a user selection of the first icon:
presenting the multi-version content;
displaying preview content of the plurality pieces of branch content when the multi-version content is presented to the multi-version production range; and
displaying, in response to a trigger operation performed on first to-be-displayed branch content in the plurality of pieces of branch content, the first to-be-displayed branch content in the multi-version production range.

19. The non-transitory computer-readable storage medium according to claim 18, wherein the multi-version content is video content, the multi-version content comprises second to-be-displayed branch content and third to-be-displayed branch content, the displaying preview content of various pieces of branch content when the multi-version content is presented to the multi-version production range comprises:
obtaining, from the remote server, a combination data packet when the multi-version content is displayed to the multi-version production range, the combination data packet being a data packet obtained by jointly encoding first n video frames of the second to-be-displayed branch content and first m video frames of the third to-be-displayed branch content, m being a positive integer, and n being a positive integer;
decoding the combination data packet, to obtain the first n video frames of the second to-be-displayed branch content and the first m video frames of the third to-be-displayed branch content; and
displaying the first n video frames of the second to-be-displayed branch content and the first m video frames of the third to-be-displayed branch content, the preview content comprising the first n video frames of the second to-be-displayed branch content and the first m video frames of the third to-be-displayed branch content.

20. The non-transitory computer-readable storage medium according to claim 19, wherein the displaying the first n video frames of the second to-be-displayed branch content and the first m video frames of the third to-be-displayed branch content comprises:
determining recommended branch content and non-recommended branch content from the second to-be-displayed branch content and the third to-be-displayed branch content; and
displaying the video frames of the recommended branch content and the video frames of the non-recommended branch content, and simultaneously playing audio of the recommended branch content.
